(19) United States
(12) Patent Application Publication
(10) Pub. No.: US 2016/0351067 A1
(43) Pub. Date: Dec. 1, 2016

(54) TALKING ALPHABET BLOCKS

(71) Applicant: David Carrie, Augusta, GA (US)

(72) Inventor: David Carrie, Augusta, GA (US)

(21) Appl. No.: 14/722,357

(22) Filed: May 27, 2015

(51) Int. Cl. G09B 17/00

(52) U.S. Cl. CPC G09B 17/006

(57) ABSTRACT

A talking alphabet block set for enabling a child to selectively hear a sound identifying a selected letter or the phonetic sound of the selected letter includes a set of single letter blocks, each associated with a single letter of the alphabet, and a toggle block. The letter blocks and the toggle block each individually include a front side on which a single letter is printed, with the front side being almost entirely defined by a push button. On the letter blocks, the push button actuator causes the actuated letter block to selectively play over an integral speaker either a sound identifying the letter associated with the block or its phonetic sound. On the toggle block, the push button actuator causes it to transmit a wireless signal receivable by the letter blocks that toggles the setting of the letter blocks between playing the identifying or phonetic sound when actuated.

### BACKGROUND OF THE INVENTION

Field of the Invention

This invention relates generally to education and demonstration devices and, more particularly, to a set of alphabet block structures adapted to selectively play an audible message identifying the letter and its sound.

Description of the Prior Art

The use and design of conventional alphabet teaching tools, such as workbooks or flash cards, is well known. A problem which still exists, however, is that such conventional tools generally require a teacher or caretaker to verbally identify selected letters, the character representing them, and their sounds for a child to begin to associate the letter with the character and phonetic sound. Thus, there remains a need for a talking alphabet block set which, for each letter of the alphabet, includes a block associated that in response to manual actuation emits a sound identifying the letter on the block or the phonetic sound of such letter. It would be helpful if such a talking alphabet block set including a separate block for each letter of the alphabet. It would be additionally desirable for essentially the entire the letter side of each discrete block of such a talking alphabet block set to define the manual actuator which activates the letter.

The Applicant's invention described herein provides for a talking alphabet block set adapted to allow a child to cause a sound identifying selected letter and phonetic sound of such letter to be selectively broadcast. The primary components in Applicant's talking alphabet block set are a plurality of discrete blocks and a toggle block in wireless communication with each discrete block. When in operation, the talking alphabet block set enables a child to be exposed to alphabet related sounds without ongoing the assistance of an adult. As a result, many of the limitations imposed by prior art structures are removed.

### SUMMARY OF THE INVENTION

A talking alphabet block set for enabling a child to selectively hear a sound identifying a selected letter or the phonetic sound of the selected letter. The talking alphabet block set includes a set of single letter blocks, each associated with a single letter of the alphabet, and a toggle block. The letter blocks and the toggle block each individually include a front side on which a single letter is printed, with the front side being almost entirely defined by a push button. On the letter blocks, the push button actuator causes the actuated letter block to selectively play over an integral speaker either a sound identifying the letter associated with the block or its phonetic sound. On the toggle block, the push button actuator causes it to transmit a wireless signal receivable by the letter blocks that toggles the setting of the letter blocks between playing the identifying or phonetic sound when actuated.

It is an object of this invention to provide a talking alphabet block set which, for each letter of the alphabet, includes a block associated that in response to manual actuation emits a sound identifying the letter on the block or the phonetic sound of such letter.

It is another object of this invention to provide a talking alphabet block set that included a separate block for each letter of the alphabet.

It is yet another object of this invention to provide a talking alphabet block set in which the entire letter side of each discrete block defines the manual actuator which activates the letter.

These and other objects will be apparent to one of skill in the art.

### BRIEF DESCRIPTION OF THE DRAWINGS

FIG. 1 is a perspective view of a talking alphabet block set built in accordance with the present invention.

FIG. 2 is a front elevational view of one letter block of a talking alphabet block set built in accordance with the present invention.

FIG. 3 is a back elevational view of one letter block of a talking alphabet block set built in accordance with the present invention.

### DETAILED DESCRIPTION OF THE INVENTION

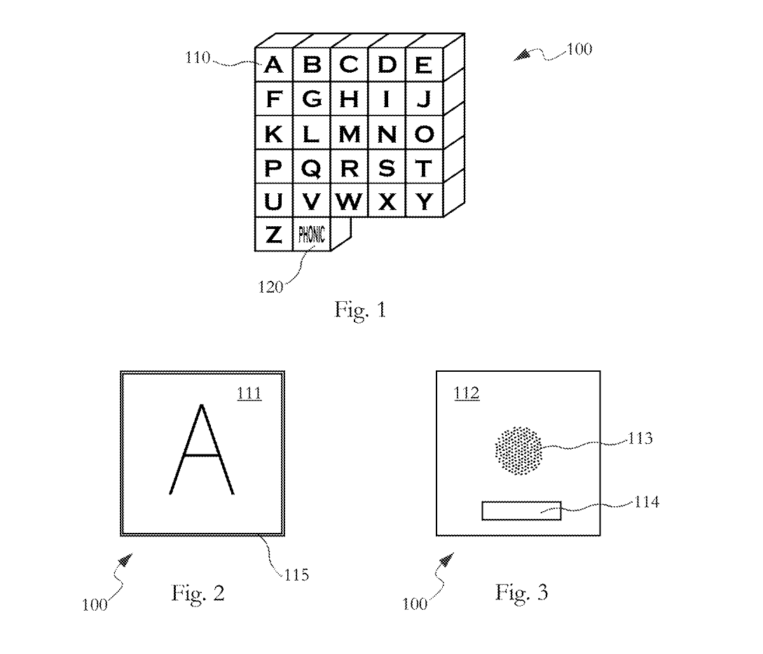

Referring now to the drawings and in particular FIGS. 1, 2, and 3, a talking alphabet block set 100 is shown as a set of single letter blocks 110, each associated with a single letter of the alphabet, and a toggle block 120. Each letter block 110 defines a rectangular, building block style block. Each letter block 110 includes a front side 111 on which a single letter is printed and a back side 112 from which a speaker 113 and a power source compartment 114 is accessible. The front side 111 is almost entirely defined by a push button actuator in that the perimeter edge 115 of the actuator extends essentially to the edge of the letter block 110. It is appreciated that having the actuator surface define the entire front side 111 is advantageous because it makes it easier for young children to actuate the push button actuator than if the actuator was a smaller button positioned somewhere on the front side 111.

Internally, each letter block 110 additionally includes a power source, a controller, and a wireless networking interface, each of which are operatively connected to each other and with the push button actuator and the speaker 113. The controller includes software which causes the letter block 110 to selectively play over the speaker 113 a sound file containing either a sound identifying the letter associated with the block 111 or a phonetic sound of the letter associated with the block 111 in response to receiving a signal generated by the push button actuator which indicates the button was pressed.

The toggle block 120 defines a rectangular block which is sized and shaped identically to the letter blocks 110. The toggle block 120 includes a front side on which “PHONIC” is printed and a back side from which a speaker and a power source compartment is accessible. As with the letter blocks 110, the front side of the toggle block is almost entirely defined by a push button actuator.

Internally, the toggle block 120 additionally includes a power source, a controller, and a wireless networking interface, each of which are operatively connected to each other and with the push button actuator and the speaker 113. The controller includes software which causes it to transmit a wireless signal receivable by the letter blocks 110 in range in response to receiving a signal generated by its push button actuator which indicates the button was pressed. The wireless signal toggles the setting of the letter blocks 110 between playing the sound identifying their associated letter when actuated or the phonetic sound when actuated.

In one embodiment, the wireless networking interface in the letter blocks 110 and toggle block 120 defines a Bluetooth antenna and the letter blocks 110 have been paired with the toggle block 120.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A talking alphabet block set, comprising:
a plurality of letter blocks each having a first side essentially defined by a defined by a letter push button actuator and a second side from which a speaker is accessible, wherein each letter block is associated with a single letter;
said plurality of letter blocks each including a power source and a controller each of which are operatively connected to each other and with the letter push button actuator and the speaker;
said plurality of letter blocks each configured to selectively play over the speaker a sound file containing either a sound identifying the letter associated with the block or a phonetic sound of the letter associated with the block in response to receiving a signal generated by the push button letter actuator which indicates the button was pressed.

2. The talking alphabet block set of claim 1, wherein said plurality of letter blocks each include a wireless networking interface operatively connected to said controller.

3. The talking alphabet block set of claim 2, wherein said plurality of letter blocks each include a Bluetooth antenna operatively connected to said controller.

4. The talking alphabet block set of claim 3, additionally comprising at least one toggle block having a first side essentially defined by a defined by a toggle push button actuator, wherein said toggle block includes a power source, wireless networking and a controller operatively connected to each other and with the toggle push button actuator and said toggle block is configured to toggle whether the letter blocks playing the sound identifying their associated letter when actuated or the phonetic sound when actuated.

5. The talking alphabet block set of claim 4, wherein the toggle block includes a Bluetooth antenna and said toggle block is paired with said letter blocks.

6. The talking alphabet block set of claim 4, wherein said toggle block is configured to transmit a wireless signal receivable by the letter blocks in response to receiving a signal generated by the toggle push button actuator of the toggle block which indicates the toggle push button actuator was pressed.

7. The talking alphabet block set of claim 2, additionally comprising at least one toggle block having a first side essentially defined by a defined by a toggle push button actuator, wherein said toggle block includes a power source, wireless networking and a controller operatively connected to each other and with the toggle push button actuator and said toggle block is configured to toggle whether the letter blocks playing the sound identifying their associated letter when actuated or the phonetic sound when actuated.

8. The talking alphabet block set of claim 7, wherein said toggle block is configured to transmit a wireless signal receivable by the letter blocks in response to receiving a signal generated by the toggle push button actuator of the toggle block which indicates the toggle push button actuator was pressed.
